(19) United States
(12) Patent Application Publication
(10) Pub. No.: US 2026/0167787 A1
(43) Pub. Date: Jun. 18, 2026

(54) MECHANICALLY ENHANCED POROUS POLYOLEFIN COMPOSITES IN BIAXIAL DIRECTION USING FILLERS WITH HIGH ASPECT RATIO

(71) Applicants: ATERA WATER PTE LTD, Singapore (SG); NANYANG TECHNOLOGICAL UNIVERSITY, Singapore (SG)

(72) Inventors: Xiao HU, Singapore (SG); Xuelong CHEN, Singapore (SG); Kee TAI, Singapore (SG); Piah Song Adrian YEO, Singapore (SG); Hui CHEN, Singapore (SG); Cai Yun Rachel YAP, Singapore (SG)

(21) Appl. No.: 19/124,290

(22) PCT Filed: Oct. 26, 2023
(86) PCT No.: PCT/SG2023/050717

§ 371 Date: Apr. 24, 2025

(30) Foreign Application Priority Data
Oct. 26, 2022 (SG) 10202251494S

(51) Int. Cl. C08J 5/18; B01D 67/00; B01D 69/02; B01D 69/14; B01D 71/26; C08K 3/04; C08K 3/34; H01M 50/417; H01M 50/431; H01M 50/446

(52) U.S. Cl. CPC C08J 5/18; B01D 67/00793; B01D 67/0083; B01D 67/0086; B01D 69/02; B01D 69/148; B01D 71/261; B01D 71/262; C08K 3/042; C08K 3/346; H01M 50/417; H01M 50/431; H01M 50/446; B01D 2325/02832; B01D 2325/02833; B01D 2325/02834; B01D 2325/20; C08J 2323/06; C08J 2323/12; C08K 2201/005; C08K 2201/011; C08K 2201/016

(57) ABSTRACT

Disclosed herein provides the porous polyolefin composites, which comprise the polyolefin polymer as the matrix and embedded fillers with high aspect ratio as the reinforcing element and are mainly featured by the enhanced mechanical properties in biaxial direction. These said composites can be used as filtering semi-permeable membranes in filtration/purification of air, water or other liquids, or can be used as separators in energy industries.

### FIELD OF INVENTION

The current invention relates to mechanically enhanced porous polyolefin composite materials containing a polymeric matrix and one or more fillers with high aspect ratio, semi-permeable membranes formed of a film of the porous composite materials, separator membranes for a battery comprising the porous composite materials, and methods of providing the porous composite materials.

### BACKGROUND

The listing or discussion of a prior-published document in this specification should not necessarily be taken as an acknowledgement that the document is part of the state of the art or is common general knowledge.

Water scarcity has been a long-standing challenge facing the world today. In view of global population boom and rapid development of manufacturing industries in the past decades, the demand of clean water has become increasingly pressing. In the meantime, many communities still struggle with the appropriate treatment and disposal of enormous amount of industrial wastewater and municipal sewage. Water scarcity and environmental pollution have posed significant threats to the livelihood of communities, as well as creating negative repercussion in environment and eco-system. According to a UN report released in 2021, today 2.3 billion people live in countries with water stress situation, about 1.42 billion people, including one-third children, living in high or extremely high water-stress regions.

Membrane technology is becoming a promising solution for the water filtration obtaining clean water. Generally, membranes can be classified as microfiltration membrane, ultrafiltration membrane, nanofiltration membrane and reverse osmosis membrane. Microfiltration is commonly used as pretreatment step for the removal of large macromolecules. Ultrafiltration allows for the removal of bacteria as well as some viruses. Nanofiltration and osmosis are used for the separation of salts. Porous membranes, made of various materials including polymers, ceramics or metals, have been used in various separation applications. Polymeric membranes have been widely used owing to the many advantages, such as the low cost, easy manufacturing and easy installation. Typical polymeric materials used for water purification membrane manufacturing include cellulose and its derivatives, PA (polyamide), PSF (polysulfone), PES (polyethersulfone), PC (polycarbonate), PEI (poly (ether imide)), PTFE (polytetrafluoroethylene), PVDF (polyvinylidenefluoride), and PAN (polyacrylonitrile).

PVDF, a semicrystalline thermoplastic fluoropolymer, is by far one of the most popular materials for making membranes which is commonly used for membrane fabrication because of its good thermal stability, resistance to most of chemicals and excellent mechanical properties. However, the high price of PVDF constrains its further and wider usage, especially in developing countries and rural areas. With the soaring demand in fuel cells and lithium batteries serving as separator, the cost of PVDF is expected to increase in a long term. Moreover, PVDF membranes are typically prepared by a phase separation method, which usually requires a large amount of organic liquid producing a series of complex toxic wastewater.

Polyolefin polymers could be economical alternatives to PVDF for manufacturing porous membrane towards water treatment, owing to the excellent chemical resistance and thermal stability. Compared with the high price of PVDF, i.e., 40˜70 thousand USD per metric ton, polyolefins are much lower in price, for example, high-density polyethylene (HDPE) is only 1216 USD per metric ton according to the data retrieved in May 2022. The price advantage makes porous polyolefin an attractive option to replace PVDF in various membrane applications. Furthermore, from the aspect of environmental sustainability, polyolefin membranes could be made from melt spinning and stretching technique, which do not involve the use of any toxic solvents, making them excellent green alternatives to PVDF membrane and other polymer membranes made by a phase separation approach.

It has been demonstrated that porous polyolefin membranes could be fabricated by either wet or dry method. F or example, U.S. Pat. No. 4,828,772 teaches how to make microporous polyethylene via the co-extrusion of polyethylene and porogen, which was followed by the removal of porogen. U.S. Pat. No. 4,530,809 describes the fabrication of HDPE hollow fibre membrane via cold stretching and hot stretching of melt extruded hollow fibres, which could achieve porous structure with porosity 30˜90% by volume. Porous polypropylene in either fibre or film shape can be obtained by drawing, as illustrated in U.S. Pat. No. 5,435,955.

Despite numerous desirable properties of polyolefins, an enhancement in mechanical properties of porous polyolefins is necessary for practical applications. Through the addition of fillers into polymers to make composites could be an effective methodology to fabricate mechanically reinforced porous polyolefins. Compared with particulate fillers with low aspect ratio, high aspect ratio fillers with aspect ratio ranging from several dozens to several thousands are more effective in reinforcing the strength of polymers. The high aspect ratio fillers are able to enhance the mechanical properties of polymers via bridging or stitching effect, and a low loading of such type of fillers could result in considerable elevation in mechanical properties.

The reinforced porous polyolefin composites can be used as membranes towards filtration/purification of air, water, or other liquids. Furthermore, the porous structure also makes the mechanically reinforced porous polyolefin composites promising to be used as separators in rechargeable batteries.

### SUMMARY OF INVENTION

It has been surprisingly found that the said porous polyolefin composites are mainly featured with increased mechanical properties in biaxial direction, and in some cases also witnessed with enhanced pore formation ability. The reinforced porous polyolefin composites could be used as filtering membranes towards filtration applications. The reinforced porous polyolefin composites could be also used as separators in rechargeable batteries. Thus, the current invention relates to said mechanically enhanced porous polyolefin composite materials containing a polymeric matrix and one or more fillers with high aspect ratio, semi-permeable filler membranes formed of a film of the porous composite materials, separator membranes for a battery comprising the porous composite materials, and methods of providing the porous composite materials.

In a first aspect, there is provided a porous polyolefin composite comprising a polyolefin matrix into which is incorporated an effective amount of fillers with high aspect ratio and possess pores in the range of 0.01 to 2 μm. The fillers can be present in the porous composites at a loading by weight of between 0.05 to 30%. The fillers can be present with or without surface modification. The fillers can be present directly in powder form or dispersed in a masterbatch.

In a second aspect, there is provided a method of providing a high aspect ratio fillers strengthened porous polyolefin composites, comprising a polyolefin matrix and fillers dispersed in polyolefin, the method comprising (a) compounding the polyolefin polymer with high aspect ratio fillers; (b) melt extruding the polyolefin composites into polyolefin composite precursor structure with a certain drawing ratio; (c) thermal annealing of polyolefin composite precursor structure at a certain temperature for a certain duration; (d) cold stretching of polyolefin composite precursor structure at a certain temperature for a certain duration; (e) hot stretching of polyolefin composite precursor structure at a certain temperature for a certain duration and (f) thermal setting of the porous polyolefin composites at a certain temperature for a certain duration.

Aspects and embodiments of the invention are described in the following numbered clauses.

1. A porous composite material, comprising:
a polymeric matrix formed from one or more polyolefins; and
one or more high aspect ratio filler materials, wherein
the porous composite material has pores having a diameter of from 0.01 to 2 μm; and
the one or more high aspect ratio filler materials are present in an amount of from 0.05 to 30 wt % of the total weight of the porous composite material.
   2. The porous composite material according to Clause 1, wherein the one or more polyolefins each have generic repeating group of formula I:

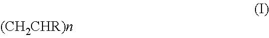

where R is an alkyl group, optionally wherein each R is a C₁ to C₁₀ alkyl group that is unbranched or branched.
   3. The porous composite material according to Clause 1 or 2, wherein the one or more polyolefins are selected from one or more of the group consisting of polyethylene (PE), polypropylene (PP), polymethylpentene (PMP), polybutene-1 (PB-1), ethylene-octene copolymers, stereo-block PP, olefin block copolymers, or propylene-butane copolymers.
   4. The porous composite material according to any one of the preceding clauses, wherein each of the one or more polyolefins has a density of from 0.80 to 0.99 g/cm³, such as from 0.90 to 0.99 g/cm³, such as from 0.94 to 0.97 g/cm³, such as from 0.89 to 0.95 g/cm³, such as from 0.92 to 0.98 g/cm³.
   5. The porous composite material according to any one of the preceding clauses, wherein each of the one or more polyolefins has a melt flow index of from 0.1 to 30 g/10 min, such as from 0.1 to 15 g/10 min, such as from 0.3 to 0.5 g/10 min at 230° C./2.16 kg, as measured according to ASTM D1238.
   6. The porous composite material according to any one of the preceding clauses, wherein the porous composite material further comprises one or more additives selected from the group consisting of stabilizers, plasticizers, lubricants, flame retardants, anti-aging materials, colorants, nucleating agents, odour-generating agents, anti-microbial materials, anti-static additives or compatilizers, optionally wherein the porous composite material further comprises a compatilizer.
   7. The porous composite material according to any one of the preceding clauses, wherein the one or more high aspect ratio filler materials are a material that has a high ratio of length or width versus cross-sectional diameter and/or thickness, where the ratio is from 5 to 100,000.
   8. The porous composite material according to any one of the preceding clauses, wherein the one or more high aspect ratio filler materials are present in an amount of from 0.05 to 30 wt %, such as from 0.1 to less than or equal to 10 wt %, such as from 0.5 to 2 wt %, such as from 0.7 to 1.5 wt % of the total weight of the porous composite material.
   9. The porous composite material according to any one of the preceding clauses, wherein at least one of the one or more high aspect ratio filler materials are surface treated, optionally wherein at least one of the one or more high aspect ratio fillers that have been surface treated has been treated by one or more of a chemical treatment and a physical treatment
   10. The porous composite material according to any one of the preceding clauses, wherein the one or more high aspect ratio filler materials are selected from one or more of a tube-like filler, a rod-like fille, a fiber, a wire, a plate-like filler, a disk-like filler, a sheet-like filler, a prism-like filler, a wall-like filler, branched structure filler, and a hybrid structure that comprises two or more of the structures mentioned herein.
   11. The porous composite material according to any one of the preceding clauses, wherein the one or more high aspect ratio filler materials have a size of from 1 nm to 1,000 μm.
   12. The porous composite material according to any one of the preceding clauses, wherein the high aspect ratio filler materials are selected from one or more of the group consisting of nanotubes, nanorods, and nanowires, such as silver nanowires, metal nanorods and carbon nanotubes.
   13. The porous composite material according to any one of the preceding clauses, wherein the polyolefin porous composite is provided in the form of a flat sheet, in the form of a hollow fibre with a diameter of between 0.05 to 2 mm, or in the form of a tubular structure with a diameter of greater than 2 mm.
   14. The porous composite material according to any one of the preceding clauses, wherein the high aspect ratio filler materials have an aspect ratio of from 5 to 100,000, such as from 500 to 36,000, such as from 5,000 to 10,000.
   15. The porous composite material according to any one of the preceding clauses, wherein the porous composite material has one or both of:
a mechanical strength that is from 5 to 1,000% higher, such as from 20 to 100% higher, such as from 30 to 50% higher in a transverse direction for a film or in a circumferential direction for a fiber/tube formed from the polyolefin alone; and
a maximum strain that that is from 10 to 50,000% higher, such as from 1,000 to 40,000% higher, such as from 10,000 to 27,000% higher in a transverse direction for a film or in a circumferential direction for a fiber/tube formed from the polyolefin alone.
   16. The porous composite material according to any one of the preceding clauses, wherein the porous composite material has one or both of:
a mechanical strength that is from 5 to 100% higher, such as from 11 to 50% higher, such as from 14 to 33% higher in a machine direction of a film or longitudinal direction of fiber/tube formed from the polyolefin alone; and
a Young's modulus that that is from 7 to 100% higher, such as from 8 to 40% higher, such as from 9 to 33% higher in a machine direction of a film or longitudinal direction of fiber/tube formed from the polyolefin alone.
   17. A semi-permeable filter membrane formed of a film of a porous composite material according to any one of Clauses 1 to 16.
   18. The semi-permeable filter membrane according to Clause 17, wherein:
the filter membrane has an average air flux of from 1,000 LMH to 10,000 LMH, such as about 5,435 LMH, when measured at 1 bar of pressure; and/or
the filter membrane has a water permeability of from 50 LMH/bar to 1000 LMH/bar, such as about 196.5 LMH/bar.
   19. A separator membrane for a battery comprising a porous composite material according to any one of Clauses 1 to 12.
   20. A method of providing a porous composite material according to any one of Clauses 1 to 18, the method comprising the steps of:
(a) providing a polyolefin composite precursor material that has been subjected to melt extrusion, thermal annealing, cold stretching and hot stretching; and
(b) subjecting the polyolefin composite precursor material that has been subjected to melt extrusion, thermal annealing, cold stretching and hot stretching to a thermal setting step at a certain temperature for a certain period of time.
   21. The method according to Clause 20, wherein one or both apply:
the temperature of the thermal setting step is from 100 to 150 QC, such as from 120 to 140° C.; and
the period of time for the thermal setting step is from 1 to 120 minutes, such as from 30 to 60 minutes.
   22. The method according to Clause 20 or Clause 21, wherein the polyolefin composite precursor material that has been subjected to melt extrusion, thermal annealing, cold stretching and hot stretching is provided by:
(ai) providing a polyolefin composite precursor material that has been subjected to melt extrusion, thermal annealing, and cold stretching; and
(aii) subjecting the polyolefin composite precursor material to hot stretching at a certain temperature, a certain length per minute and at a certain extension.
   23. The method according to Clause 22, wherein one or both apply:
the temperature of the hot stretching is from 100 to 150 QC;
the length per minute of the hot stretching is from 1 mm/min to 200 mm/min, such as from 8 mm/min to 40 mm/min.
   24. The method according to any one of Clauses 20 to 23, wherein the polyolefin composite precursor material that has been subjected to melt extrusion, thermal annealing, and cold stretching is provided by:
(bi) providing a polyolefin composite precursor material that has been subjected to melt extrusion, thermal annealing, and cold stretching; and
(bii) subjecting the polyolefin composite precursor material to cold stretching at a certain temperature, a certain length per minute and at a certain extension.
   25. The method according to Clause 24, wherein one or both apply:
the temperature of the cold stretching is from −196 to 100° C., such as from 20 to 30° C., such as about 25° C.;
the length per minute of the cold stretching is from 1 mm/min to 600 mm/min, such as from 10 mm/min to 200 mm/min, such as from 50 to 100 mm/min.
   26. The method according to any one of Clauses 21 to 25, wherein the polyolefin composite precursor material that has been subjected to melt extrusion and thermal annealing is provided by:
(ci) providing a polyolefin composite precursor material that has been subjected to melt extrusion and thermal annealing; and
(cii) subjecting the polyolefin composite precursor material to thermal annealing at a certain temperature for a certain period of time.
   27. The method according to Clause 26, wherein one or both apply:
the temperature of the thermal annealing is from 100 to 150° C., such as from 110 to 140° C.; and
the period of time for the thermal annealing is from 1 minutes to 10 hours, such as from 30 minutes to 8 hours.
   28. The method according to any one of Clauses 20 to 25, wherein the polyolefin composite precursor material that has been subjected to melt extrusion is provided by:
(di) providing a polyolefin composite precursor material comprising components as described in anyone of Clauses 1 to 16; and
(dii) subjecting the polyolefin composite precursor material to melt extrusion at a certain temperature and at a certain draw ratio.
   29. The method according to Clause 28, wherein one or both apply:
the temperature of the melt extrusion is from 150 to 250° C., such as from 160 to 220° C.; and
the draw ratio for the melt extrusion is from 20 to 10,000.

### DRAWINGS

FIG. 1 depicts the SEM images of porous neat HDPE film at (a) 5000× and (b) 10000× magnification.

FIG. 2 depicts the SEM images of porous HDPE/CNTs (0.7 wt %) composite film at (a) 5000× and (b) 10000× magnification.

FIG. 3 depicts (a) the SEM image and (b) the TEM image of carbon nanotube (CNT) used.

FIG. 4 depicts the SEM images of porous HDPE/clay (3 wt %) composite film at (a) 5000× and (b) 10000× magnification.

FIG. 5 depicts the SEM image of clay used.

FIG. 6 depicts one representative AFM image of clay used (Clay 1) and its thickness.

FIG. 7 depicts another representative AFM image of clay used (Clay 2) and its thickness.

FIG. 8 depicts the SEM image of neat PP porous hollow fibre.

FIG. 9 depicts the SEM image of graphene composite porous hollow fibre with 0.1 wt % graphene.

FIG. 10 depicts the SEM image of graphene composite porous hollow fibre with 0.2 wt % graphene.

### DESCRIPTION

Porous polyolefin composites are promising alternatives to PVDF in water treatment membranes. It has been surprisingly found that the introduction of fillers with a high aspect ratio is a facile and effective way to enhance the mechanical performance of porous polyolefins.

Thus, in a first aspect of the invention, there is provided a porous composite material, comprising:
a polymeric matrix formed from one or more polyolefins; and
one or more high aspect ratio filler materials, wherein
the porous composite material has pores having a diameter of from 0.01 to 2 μm; and
the one or more high aspect ratio filler materials are present in an amount of from 0.05 to 30 wt % of the total weight of the porous composite material.

The word “comprising” refers herein may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a composition” includes mixtures of two or more such compositions, and the like.

In the present invention, the term “polyolefin” refers to a group of polymers with the general formula (CH₂CHR)n where “R” is an alkyl group. They are usually prepared by polymerization of simple olefins (alkenes).

Thus, in embodiments of the invention, the one or more polyolefins may each have generic repeating group of formula I:

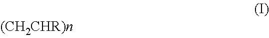

where R is an alkyl group.

Unless otherwise stated, the term “alkyl” refers to an unbranched or branched, acyclic or cyclic, saturated hydrocarbyl radical, which may be substituted or unsubstituted (with, for example, one or more halo atoms). Where the term “alkyl” refers to an acyclic group, it is preferably C₁₋₁₀ alkyl and, more preferably, C₁₋₆ alkyl (such as ethyl, propyl, (e.g. n-propyl or isopropyl), butyl (e.g. branched or unbranched butyl), pentyl or, more preferably, methyl). Where the term “alkyl” is a cyclic group (which may be where the group “cycloalkyl” is specified), it is preferably C₃₋₁₂ cycloalkyl and, more preferably, C₅₋₁₀ (e.g. C₅₋₇) cycloalkyl.

In particular embodiments of the invention, each R may be is a C₁ to C₁₀ alkyl group that is unbranched or branched. In particular embodiments of the invention, the alkyl groups may be acyclic.

In particular embodiments of the invention, the one or more polyolefins are selected from one or more of the group consisting of polyethylene (PE), polypropylene (PP), polymethylpentene (PMP), polybutene-1 (PB-1), ethylene-octene copolymers, stereo-block PP, olefin block copolymers, or propylene-butane copolymers.

In certain embodiments, the one or more polyolefins may be polypropylene and/or polyethylene. In some other cases, the one or more polyolefins used to fabricate the porous composites may consist of one type of polyolefin, while in other cases a combination of two or more types of polyolefin may be used as a blend. It will be appreciated, copolymers (whether random or block) may be formed through the use of one or more of the polyolefins discussed herein and these may also be used in the embodiments of the invention.

The polyolefins can be of varying densities, for example ranging from 0.94 to 0.97 g/cm³, or in the range of 0.89-0.95 g/cm³, or in the range of 0.92-0.98 g/cm³. The said polyolefins may possess melt indexes in the range of typically 0.1 to 30 g/10 min (@230° C./2.16 kg, ASTM D1238).

In more particular embodiments of the invention, the one or more polyolefins may have a density of from 0.8 to 0.99 g/cm³, such as from 0.9 to 0.99 g/cm³, such as from 0.94 to 0.97 g/cm³, such as from 0.89 to 0.95 g/cm³, such as from 0.92 to 0.98 g/cm³. For the avoidance of doubt, it is explicitly contemplated that where a number of numerical ranges related to the same feature are cited herein, that the end points for each range are intended to be combined in any order to provide further contemplated (and implicitly disclosed) ranges. For example, the ranges in this paragraph are explicitly intended to provide the following sub-ranges:
from 0.8 to 0.89 g/cm³, from 0.8 to 0.9 g/cm³, from 0.8 to 0.92 g/cm³, from 0.8 to 0.94 g/cm³, from 0.8 to 0.95 g/cm³, from 0.8 to 0.97 g/cm³, from 0.8 to 0.98 g/cm³, from 0.8 to 0.99 g/cm³;
from 0.89 to 0.9 g/cm³, from 0.89 to 0.92 g/cm³, from 0.89 to 0.94 g/cm³, from 0.89 to 0.95 g/cm³, from 0.89 to 0.97 g/cm³, from 0.89 to 0.98 g/cm³, from 0.89 to 0.99 g/cm³;
from 0.9 to 0.92 g/cm³, from 0.9 to 0.94 g/cm³, from 0.9 to 0.95 g/cm³, from 0.9 to 0.97 g/cm³, from 0.9 to 0.98 g/cm³, from 0.9 to 0.99 g/cm³;
from 0.92 to 0.94 g/cm³, from 0.92 to 0.95 g/cm³, from 0.92 to 0.97 g/cm³, from 0.92 to 0.98 g/cm³, from 0.92 to 0.99 g/cm³;
from 0.94 to 0.95 g/cm³, from 0.94 to 0.97 g/cm³, from 0.94 to 0.98 g/cm³, from 0.94 to 0.99 g/cm³;
from 0.95 to 0.97 g/cm³, from 0.95 to 0.98 g/cm³, from 0.95 to 0.99 g/cm³;
from 0.97 to 0.98 g/cm³, from 0.97 to 0.99 g/cm³; and
from 0.98 g/cm³ to 0.99 g/cm³.

In embodiments of the invention, the each of the one or more polyolefins may have a melt flow index of from 0.1 to 30 g/10 min, such as from 0.1 to 15 g/10 min, such as from 0.3 to 0.5 g/10 min at 230° C./2.16 kg, as measured according to ASTM D1238.

In some cases, the polyolefin could also be polyolefin polymers with or without other additives, such as processing aids. The processing aids may include but are not limited to stabilizers, plasticizers, lubricants, flame retardants, anti-aging materials, colorants, nucleating agents, odour-generating agents, anti-microbial materials, anti-static additives, compatilizers and combinations thereof. In particular embodiments of the invention that may be mentioned herein, the porous composite material may further comprise a compatilizer.

In particular, the compatilizer refers to one type of materials that are added to a mixture of incompatible materials to suppress the phase separation via enhancing the interactions between the components within the mixture. Even more particularly in this invention, the compatilizer may be used to increase the interfacial strength between the fillers and polyolefin polymer matrix.

In various embodiments, the high aspect ratio filler materials may be present with a loading higher or equal to 0.05 wt. % and less than 30 wt %, preferably with a loading higher or equal to 0.1 wt % and less than 10 wt %, preferably with a loading higher or equal to 0.5 wt % and less than 10 wt %. The loading percentage is calculated based on the total weights of the porous composite material. In more particular embodiments of the invention, the one or more high aspect ratio filler materials may be present in an amount of from 0.05 to 30 wt %, such as from 0.1 to less than or equal to 10 wt %, such as from 0.5 to 2 wt %, such as from 0.7 to 1.5 wt % of the total weight of the porous composite material.

The high aspect ratio filler materials used herein are materials that can be incorporated into specific matrices to achieve (i.e. improve) certain properties, such as one or more of mechanical, thermal, electrical properties and the like. In particular, the high aspect ratio filler materials used herein may be used to enhance the mechanical properties of a porous polyolefin.

The said high aspect ratio filler materials can be categorized into different types according to their size, morphology, physical and chemical properties. Based on the composition, some of the high aspect ratio filler materials may be carbon-based materials, metal nanomaterials, ceramic nanomaterials, polymers, and lipids.

The one or more high aspect ratio filler materials are a material that has a high ratio of length or width versus cross-sectional diameter and/or thickness. For example, these ratios may be from 5 to 100,000. More particularly, the high aspect ratio filler materials may have an aspect ratio of from 5 to 100,000, such as from 500 to 36,000, such as from 5,000 to 10,000.

The one or more high aspect ratio filler materials may be any suitable material. For example, the one or more high aspect ratio filler materials may be selected from one or more of a tube-like filler, a rod-like fille, a fiber, a wire, a plate-like filler, a disk-like filler, a sheet-like filler, a prism-like filler, a wall-like filler, branched structure filler, and a hybrid structure that comprises two or more of the structures mentioned herein.

For example, the one or more high aspect ratio filler materials may be fibrous fillers with a high ratio of filler length over the filler diameter. This type of filler may contain various tube-like fillers, rod-like filler, fibers, and wires. For example, carbon nanotubes, silver wires, and metal rods. In some embodiments, the fibrous filler particularly refers to carbon nanotubes.

High aspect ratio filler materials that have a plate or a disk-like form have a high ratio of planar length over the filler thickness. Various sheet-like, disk-like, plate-like, prism-like, wall-like, and other branched structures fall within this group. Some typical examples include, but are not limited to graphene, clay, and MXenes. In some embodiments, the plate or a disk-like filler may particularly refer to a graphene.

In the present invention, the one or more high aspect ratio filler materials may be present with or without surface treatments. The surface treatments refer to a process that modifies the surface properties of the high aspect ratio filler materials, either by chemical methods or physical methods, to increase the processing ability of fillers. In particular, the purpose of surface treatments is to facilitate the dispersion of the high aspect ratio filler materials, or to enhance the interfacial strength between the high aspect ratio filler materials and the polyolefin polymer matrix. By chemical treatment methods, the surface of the high aspect ratio filler materials are chemically linked to other species, such as silane coupling agents. By physical treatment methods, the surface of the high aspect ratio filler materials are physically attached with or connected to other species. One or more chemical and physical treatments may be applied, along with combinations thereof.

In particular embodiments of the invention, the high aspect ratio filler materials may be selected from one or more of the group consisting of nanotubes, nanorods, and nanowires, such as silver nanowires, metal nanorods and carbon nanotubes.

The one or more high aspect ratio filler materials may have any suitable size, for example from nano-scale to micro-scale. In particular embodiments of the invention, the one or more high aspect ratio filler materials may have a size of from 1 nm to 1,000 μm.

The porous composite material described herein may have particularly good properties. These may include one or both of:
a mechanical strength that is from 5 to 1,000% higher, such as from 20 to 100% higher, such as from 30 to 50% higher in a transverse direction for a film or in a circumferential direction for a fiber/tube formed from the polyolefin alone; and
a maximum strain that that is from 10 to 50,000% higher, such as from 1,000 to 40,000% higher, such as from 10,000 to 27,000% higher in a transverse direction for a film or in a circumferential direction for a fiber/tube formed from the polyolefin alone. In particular embodiments of the invention that may be mentioned herein, the porous composite material may have one or both of the following properties:
a mechanical strength that is from 5 to 100% higher, such as from 11 to 50% higher, such as from 14 to 33% higher in a machine direction of a film or longitudinal direction of fiber/tube formed from the polyolefin alone; and
a Young's modulus that that is from 7 to 100% higher, such as from 8 to 40% higher, such as from 9 to 33% higher in a machine direction of a film or longitudinal direction of fiber/tube formed from the polyolefin alone.

The porous composite material described herein may be used in any suitable application. One such application may be as a semi-permeable filter membrane. Thus in a further aspect of the invention there is provided a semi-permeable filter membrane formed of a film of a porous composite material as described herein. In certain embodiments that may be mentioned herein, the filter membrane may have an average air flux of from 1,000 LMH to 10,000 LMH, such as about 5,435 LMH, when measured at 1 bar of pressure. In other embodiments, the filter membrane may have a water permeability of from 50 to 1,000 LMH/bar, such as 196.5 LMH/bar.

A further application for which the porous composite material described herein may be used is as a separator membrane. Thus in a further aspect of the invention there is provided a separator membrane for a battery comprising a porous composite material as described herein.

The porous composite material described herein may be formed by any suitable method. Thus, in a further aspect of the invention, there is provided a method of providing a porous composite material as described herein, the method comprising the steps of:
providing a polyolefin composite precursor material that has been subjected to melt extrusion, thermal annealing, cold stretching and hot stretching; and
subjecting the polyolefin composite precursor material that has been subjected to melt extrusion, thermal annealing, cold stretching and hot stretching to a thermal setting step at a certain temperature for a certain period of time. In the method described herein, one or both of the following may apply:
the temperature of the thermal setting step may be from 100 to 150 QC, such as from 120 to 140° C.; and
the period of time for the thermal setting step may be from 1 to 120 minutes, such as from 30 to 60 minutes.

The polyolefin composite precursor material that has been subjected to melt extrusion, thermal annealing, cold stretching and hot stretching may be provided by:
(ai) providing a polyolefin composite precursor material that has been subjected to melt extrusion, thermal annealing, and cold stretching; and
(aii) subjecting the polyolefin composite precursor material to hot stretching at a certain temperature, a certain length per minute and at a certain extension. In such embodiments, one or both of the following may apply:
   the temperature of the hot stretching may be from 100 to 150 QC;
   the length per minute of the hot stretching may be from 1 mm/min to 200 mm/min, such as from 8 mm/min to 40 mm/min.

The polyolefin composite precursor material that has been subjected to melt extrusion, thermal annealing, and cold stretching may be provided by:
(bi) providing a polyolefin composite precursor material that has been subjected to melt extrusion, thermal annealing, and cold stretching; and
(bii) subjecting the polyolefin composite precursor material to cold stretching at a certain temperature, a certain length per minute and at a certain extension. In such embodiments, one or both of the following may apply:
   the temperature of the cold stretching may be from −196 to 100° C., such as from 20 to 30° C., such as about 25° C.;
   the length per minute of the cold stretching may be from 1 mm/min to 600 mm/min, such as from 10 mm/min to 200 mm/min, such as from 50 to 100 mm/min.

The polyolefin composite precursor material that has been subjected to melt extrusion and thermal annealing may be provided by:
(ci) providing a polyolefin composite precursor material that has been subjected to melt extrusion and thermal annealing; and
(cii) subjecting the polyolefin composite precursor material to thermal annealing at a certain temperature for a certain period of time. In such embodiments, one or both of the following may apply:
   the temperature of the thermal annealing may be from 100 to 150° C., such as from 110 to 140° C.; and
   the period of time for the thermal annealing may be from 1 minutes to 10 hours, such as from 30 minutes to 8 hours.

The polyolefin composite precursor material that has been subjected to melt extrusion may be provided by:
(di) providing a polyolefin composite precursor material comprising components as described herein; and
(dii) subjecting the polyolefin composite precursor material to melt extrusion at a certain temperature and at a certain draw ratio. In such embodiments, one or both of the following may apply:
   the temperature of the melt extrusion may be from 150 to 250° C., such as from 160 to 220° C.; and
   the draw ratio for the melt extrusion may be from 20 to 10,000.

The exact ratio used will depend on the shape of the porous polyolefin composite that is desired. That is, the draw ratio will have a very large difference between what a membrane in the form of a flat sheet requires and what a membrane in the form of fibers requires. As such, for a flat sheet the draw ratio may be from 20 to 200, the draw ratio for hollow fibers may be from 500 to 10,000.

For example, the porous composite material described herein may be obtained by mixing polyolefin resins either with a masterbatch containing a high loading of the high aspect ratio filler materials or by directly adding the high aspect ratio filler materials in powder form to an extruder containing the polyolefin, where the extruder is at a temperature that is higher than the melting point of the polyolefin. When used herein, masterbatch refers to a composite containing a higher loading of fillers than in the final porous composite material. The compounding process to form the masterbatch involves mixing high aspect ratio filler materials with polyolefins in either single or twin extruder, at varying temperatures, such as 130 to 250° C., preferably at temperature above or equal to 160 and below or equal to 220° C., depending on the type of polyolefin used. The compounding may be performed by using a screw speed ranging from 5 to 200 rad/minute and duration 1 to 30 minutes, preferably using a screw speed ranging from 50 to 150 rad/minute and a duration 3 to 15 minutes. The compounding can be carried out with or without the gas protection, for example nitrogen.

The porous composite material may be melt-extruded into any suitable precursor structure, such as a flat sheet, which can be fabricated by film casting equipment. The composite polyolefin precursor film can also be made into other form factors, such as being fibrous shape, which can be fabricated by fibre spinning apparatus. A drawing process during the composite polyolefin precursor film fabrication is necessary to increase the crystallization of polyolefin and alignment of crystals. In particular, the composite polyolefin precursor flat sheet or film can be fabricated with a drawing ratio 30 to 300, achieving the thickness typically ranging from 10 to 100 μm, preferably in the range of 10 to 50 μm The composite polyolefin precursor fibre can be fabricated with a drawing ratio 500 to 10,000, achieving a diameter of from 200 to 1000 μm, preferably in the range of from 400 to 700 μm.

A heat treatment process, or termed as thermal annealing, is often necessary to further enhance the crystallization of polyolefin and alignment of crystals. The heat treatment process can be performed 1 to 30° C. below the melting point of the polyolefin polymers. For example, the annealing process can be carried out at 100 to 130° C. for HDPE, preferably in the range of 115 to 130° C., depending on the actual melting point of HDPE. For another example, the annealing process can be carried out at 120 to 170° C. for PP, preferably in the range of 120 to 150° C., depending on the actual melting point of PP. The annealing process can last from 1 minute to a few hours, depending on the type of polyolefin and the annealing temperature. Normally, a higher annealing temperature requires a shorter annealing duration.

Annealed polyolefin composite precursors are subject to stretching process to produce porous structure. The stretching process contains two stages, with the first stretch performed at a lower temperature, while the other stage performed at relatively higher temperature.

The first stretch can be carried out at a temperature between −196 to 100° C., preferably at temperatures between 20 and 40° C., depending on the type of polyolefin polymer. In particular, the first stretch can be performed at room temperature. In particular, the stretching speed can be in the range of 1 to 1000 mm/min, preferably with a speed in the range of 10 to 100 mm/min, depending on the type of polyolefin polymers and depending on the form of the sample.

The second stretch can be performed 1 to 30° C. below the melting point of the polyolefin or polyolefin composites. For example, the second stretch can be carried out at 100 to 130° C. for HDPE, preferably in the range of 115 to 130° C., depending on the actual melting point of HDPE. For another example, the second stretch can be carried out at 120 to 170° C. for PP, preferably in the range of 120 to 150° C., depending on the actual melting point of PP. The stretching speed can be in the range of 1 to 200 mm/min, preferably with a speed in the range of 5 to 50 mm/min, depending on the type of polyolefin polymers. In the present invention, the total stretching ratio including the first stretch and second stretch process can be within the range of 50% to 1000% based on the original length of precursors prior to stretching process.

A second heat treatment process is often necessary to stabilize the porous structure of porous polyolefin composite after the stretch processes. The second heat treatment process can be performed 1 to 30° C. below the melting point of the polyolefin polymers or polyolefin composites. For example, the second heat treatment process can be carried out at 100 to 130° C. for HDPE, preferably in the range of 115 to 130° C., depending on the actual melting point of HDPE. For another example, the second heat treatment process can be carried out at 120 to 170° C. for PP, preferably in the range of 120 to 150° C., depending on the actual melting point of PP. The second heat treatment process can last from 1 minute to a few hours, depending on the type of polyolefin and the heat treatment temperature. Normally, a higher heat treatment temperature requires a shorter heat treatment duration.

Further aspects and embodiments of the invention will now be described by reference to the following non-limiting embodiments.

### EXAMPLES

### Materials

HDPE and PP were purchased from LyondellBasell and Sabic respectively. CNT-PE masterbatch was bought from CNano Technology Limited. Clay masterbatch was supplied by Chinese Academy of Sciences. Graphene-PP masterbatch was provided by Jixi Hanyu graphene technology Co., Ltd. Isopropyl alcohol was purchased from Aik Moh.

### Example 1. General Protocol of Porous Polyolefin Composites Fabrication and Characterisation

### Fabrication of Porous Polyolefin Composite Structures

The porous polyolefin composite are fabricated by subjecting the polyolefin composite precursor material that has been subjected to melt extrusion, thermal annealing, first stretching and second stretching to a thermal setting step at a certain temperature for a certain period of time. The polyolefin composites is obtained by compounding process, which involves mixing masterbatch or fillers with polyolefins in either single or twin extruder at varying temperatures.

### Characterisation of the Porous Polyolefin Composite Structures

The porous polyolefin composite structures are then characterized by electron microscopies, mechanical properties, pore size analyser and filtration test.

### Field Emission Scanning Electron Microscopy (FESEM)

The morphology of samples was studied by Field Emission Scanning Electron Microscope (FESEM) JEOL JSM-7600F.

### Mechanical Properties Tests

The mechanical properties of composites in the form of flat sheet were tested in the machine direction (MD) and transverse direction (TD), and the value of strength, Young's modulus and strain at break were calculated. Mechanical testing was performed according to ASTM D638 method using the MTS Criterion Electromechanical Test System Model C43. To determine the mechanical properties of porous composite in the form of fibrous shape, fibre segment of 20 mm were stretched by the mechanical tester until breakage with crosshead speed 50 mm/min.

### Filtration Tests

Filtration tests were performed to evaluate the flux and permeance of the porous polyolefin composite structures. A gas or liquid filtration set up, comprising of a sample holder, a pressure vessel and an air or liquid measurement system was used to carry out filtration to determine the filtration performance of the porous composite structure.

Flux of a membrane is defined as the amount of permeate produced per unit area of membrane surface per unit time (Eq. 1).

$$J = \frac{V}{A \cdot T} \qquad Eq . 1$$

where J is filtrate flux rate

$$( \frac{Liters}{{m}^{2} \cdot hours} ) ,$$

V is volume of filtrate generated (Liters), A is membrane area (m²) and T is filtration time (hours).

The permeability of porous polyolefin film is defined as the rate of diffusion of molecules or ions across the membrane. In the application of filtration membranes, the permeability of the membrane can be determined using Eq. 2:

$${L}_{p} = \frac{J}{Δ P} \qquad Eq . 2$$

where L is the permeability of membrane

$$( \frac{Liters}{{m}^{2} \cdot hours \cdot bar} ) ,$$

J is the filtrate flux rate

$$( \frac{Liters}{{m}^{2} \cdot hours} )$$

and ΔP is the pressure applied across the membrane (bar). Filtration can be performed at transmembrane pressures ranging from 0.05 to 2 bar and the permeate is collected and weighed to determine the average flux of the porous structures.

### Example 2. Comparison of Porous Neat HDPE Film and Porous HDPE/CNTs Composite Film with 0.7 wt % of CNT

Porous neat HDPE film and porous HDPE/CNTs composite film with 0.7 wt % of CNT were fabricated and characterised according to the general protocol disclosed in Example 1.

Fabrication of Porous HDPE/CNTs Composite Film with 0.7 wt % of CNT

A high-density polyethylene (HDPE) having a density of 0.95 g/cm³ and a melt flow index (MFI) of 0.45 g/10 min (@190° C./2.16 kg) was compounded with carbon nanotube masterbatch with 15 wt % loading at a temperature of 160° C. using a twin extruder. The carbon nanotube used has average diameter 7-12 nm and length about 50-250 μm. The polyolefin composite that consisted of 0.7 wt % of CNT was melt extruded into thin films at a temperature of 195° C. with a draw ratio of 75. The obtained film was subsequently annealed at a temperature of 120° C. for 4 hours before stretched at 400 mm/min for an extension of 60% in length at room temperature and further stretched at 10 mm/min for an extension of 100% in length at 120° C. Afterwards, the stretched sample was thermally treated at 120° C. for 15 minutes.

### Fabrication of Porous Neat HDPE Film

The porous film fabrication steps for neat HDPE are the same as described above and in Example 1, with the exclusion of the compounding stage.

FESEM of the CNT Used, Porous Neat HDPE Film, and Porous HDPE/CNTs Composite Film with 0.7 wt % of CNT

The SEM images of the CNT used, porous neat HDPE film and porous HDPE/CNTs composite film (0.7 wt %) were measured by following the protocol in Example 1.

### TEM Image of Carbon Nanotubes

The TEM image was obtained by FEI Tecnai G2 F30 TEM.

Mechanical Properties Test of Porous Neat HDPE Film and Porous HDPE/CNTs Composite Film with 0.7 wt % of CNT

Neat porous HDPE and porous HDPE/CNTs composite film (0.7 wt %) were tested mechanically in both machine and transverse directions according to the general protocol described in Example 1.

Filtration Tests of Porous Neat HDPE Film and Porous HDPE/CNTs Composite Film with 0.7 wt % of CNT

Filtration performance tests are carried out as described in Example 1.

### Results and Discussions

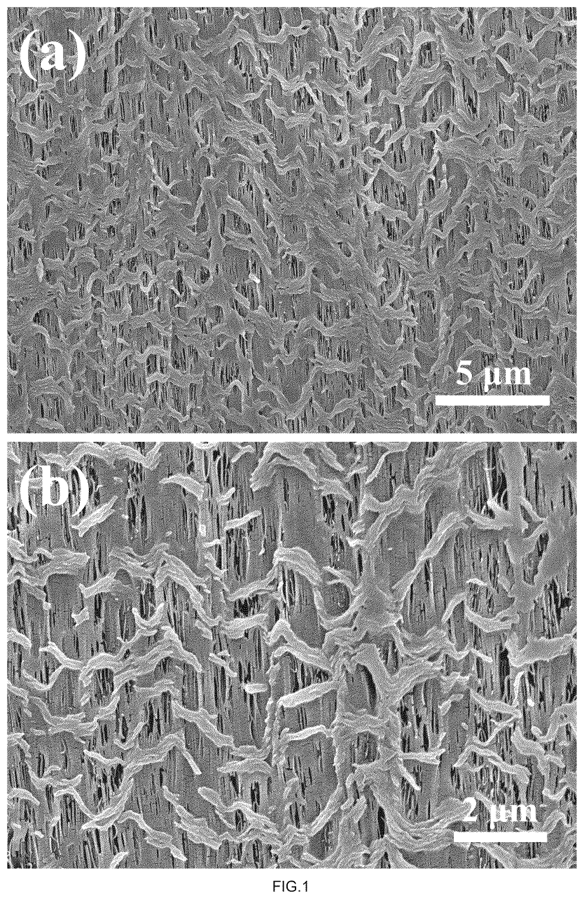

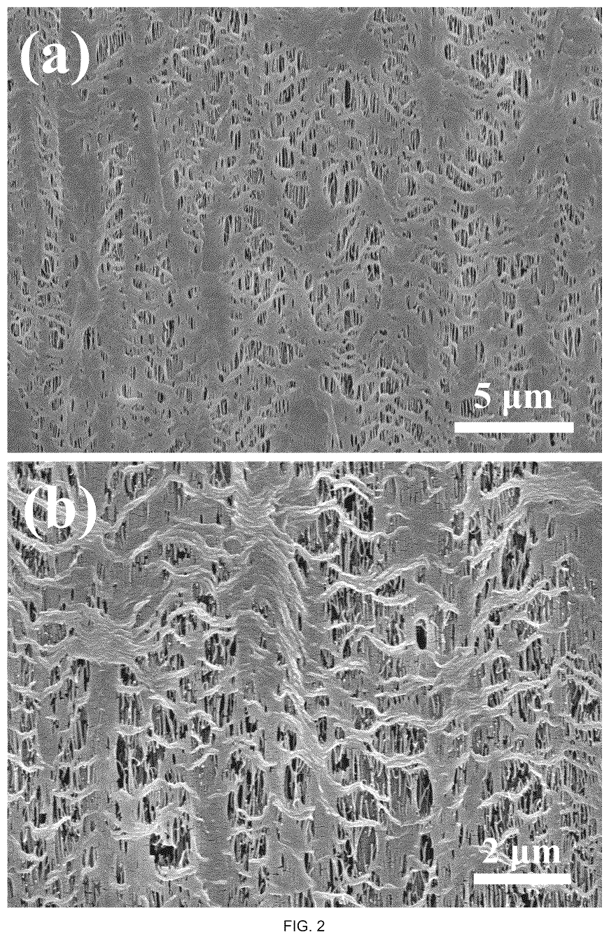

The SE M images of both neat HDPE and HDPE/CNTs composite film were shown in FIG. 1 and FIG. 2. It is clearly seen that for both HDPE and HDPE/CNTs composite film (0.7 wt %) were created with plenty of pores.

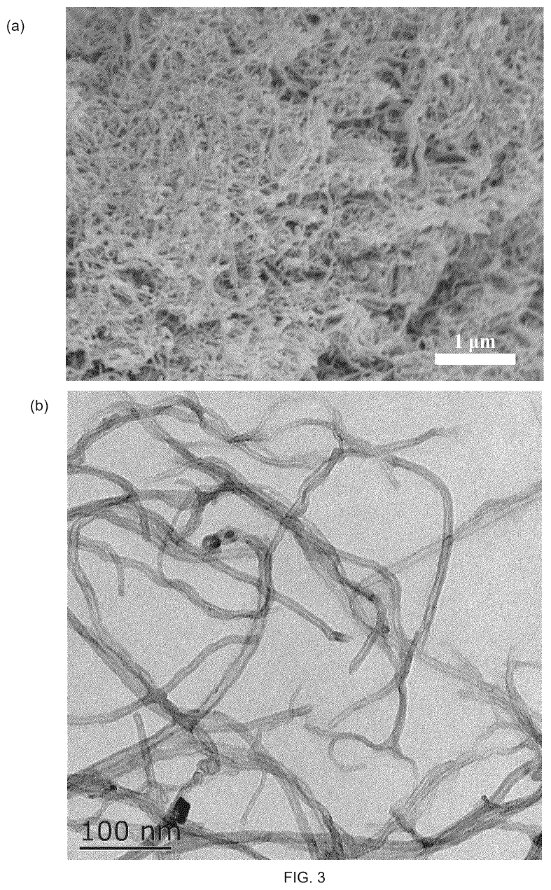

The carbon nanotube used has average diameter 7-12 nm and length about 50-250 μm, which makes the aspect ratio (length/diameter) in the range of about 4200 to 36000 (FIG. 3). The introduction of CNT fillers with such high aspect ratio has shown to enhance the mechanical performance of porous polyolefins. Neat porous HDPE and porous HDPE/CNTs composite film (0.7 wt %) were tested mechanically in both machine and transverse directions. In the machine direction, the strength of neat HDPE films was found to have an average of 113 MPa while the value increased by 7.1% to 121 MPa for porous HDPE/CNTs composite film (0.7 wt %), while no appreciable change in modulus and maximum strain. In transverse direction, the strength increased from 6.81 MPa of HDPE film to 9.6 MP a of HDPE/CNTs composite film (0.7 wt %), achieving an increment of 41%. The average strain at break for HDPE/CNTs composite film (0.7 wt %) was found to have a value of 2807%, as compared to 10.4% for neat HDPE, achieving an improvement of 26890.4%. No appreciable change in modulus was observed, probably due to the variations in porosities. These mechanical data in transverse direction were summarized in Table 1.

TABLE 1
Mechanical properties of porous neat HDPE and porous HDPE/CNTs
composite film (0.7 wt %) (Transverse Direction).

| | | |
|---|---|---|
| | HDPE/CNTs | |
| Neat HDPE | (0.7 wt %) | Change (Δ) |

| | | | | | |
|---|---|---|---|---|---|
| Strength (MPa) | 6.81 | (1.88) | 9.6 | (1.2) | 41.0% |
| Strain (%) | 10.4 | (5.2) | 2807 | (304) | 26890.4% |

Note:
the value in the bracket is the standard deviation.

Filtration performance tests are carried out as described. The average air flux for the neat HDPE membranes was calculated to be 270 LMH and that for HDPE/CNTs composite film (0.7 wt %) was 5435 LMH when measured at 1 bar of pressure. There was an increase in air flux by 2000% with the addition of 0.7 wt % CNT in HDPE films. Isopropyl alcohol was used to measure the liquid permeability of HDPE/CNTs composite film (0.7 wt %) and the flux was determined to be 45 LMH at 1 bar of pressure. The higher flux performance and observations from the SEM images indicate that the addition of CNTs can enhance the pores formation ability, without compromising the mechanical properties.

### Example 3. Comparison of Porous Neat HDPE Film and Porous HDPE/CNTs Composite Film with 1.5 wt % of CNT

Porous neat HDPE film and porous HDPE/CNTs composite film with 1.5 wt % of CNT were fabricated and characterised according to the general protocol disclosed in Example 1.

Fabrication of Porous HDPE/CNTs Composite Film with 1.5 wt % of CNT

A HDPE having a density of 0.95 g/cm³ and MFI of 0.4 was compounded with 1.5 wt % CNTs at a temperature of 160° C. using twin extruder. The carbon nanotube used has average diameter 7-12 nm and length about 50-250 μm. The composite was then melted extruded into thin film at a temperature of 195° C. at a draw ratio of 75. The HDPE/CNTs composite film (1.5 wt %) were subsequently annealed at a temperature of 110° C. for 2 hours before stretched at 480 mm/min for an extension of 45% in length at room temperature and further stretched at 8 mm/min for an extension of 80% in length at 120° C. Afterwards, the stretched films were further heat treated at 120° C. for 10 minutes.

### Fabrication of Porous Neat HDPE Film

The film fabrication steps for neat HDPE films are the same as described above and in Example 1, with the exclusion of the compounding stage.

Mechanical Properties Test of Porous Neat HDPE Film and Porous HDPE/CNTs Composite Film with 1.5 wt % of CNT

Both porous neat HDPE and porous HDPE/CNTs composite film (1.5 wt %) were tested mechanically in machine direction according to the general protocol described in Example 1.

### Results and Discussions

The strength of porous neat HDPE films was tested to have an average of 87.5 MPa while the porous HDPE/CNTs composite film (1.5 wt %) obtained an average strength of 112.5 MPa, achieving an improvement of 28.6%. The Young's modulus increased from 327.8 MPa of neat HDPE film by 21.5% to 398.4 MPa of HDPE/CNTs composite film (1.5 wt %). While the apparent improvements in strength and modulus, there is no appreciable change in strain of breakage. These results were summarized in Table 2.

TABLE 2
Mechanical properties of porous neat HDPE and porous HDPE/CNTs
composite film (1.5 wt %) (Machine Direction).

| | | | HDPE/CNTs | | |
|---|---|---|---|---|---|
| | Neat HDPE | | (1.5 wt %) | | Change (Δ) |
| Strength (MPa) | 87.5 | (9.8) | 112.5 | (17.0) | 28.6% |
| Young's Modulus | 327.8 | (31.5) | 398.4 | (58.7) | 21.5% |
| (MPa) | | | | | |

Note:
the value in the bracket is the standard deviation.

The carbon nanotube used has average diameter 7-12 nm and length about 50-250 μm, which makes the aspect ratio (length/diameter) in the range of about 4200 to 36000 (FIG. 3). The introduction of CNT fillers with such high aspect ratio has also shown enhancement in the mechanical performance of porous polyolefins in this Example.

### Example 4. Comparison of Porous Neat HDPE Film and Porous HDPE/Clay Composite Film

Porous neat HDPE film and porous HDPE/Clay composite film were fabricated and characterised according to the general protocol disclosed in Example 1.

### Fabrication of Porous HDPE/Clay Composite Film

A HDPE having a density of 0.95 g/cm³ and a melt index of 0.4 was compounded with clay at a temperature of 160° C. using a twin extruder. The clay used has average thickness 1 nm and planar length about 0.5-5 μm. The composite which consisted of 3 wt % clay as well as compatilizer were melt extruded into thin films at a temperature of 195° C. at a draw ratio of 75. The HDPE/clay (3 wt %) film were subsequently annealed at a temperature of 117° C. for 8 hours before stretched at 500 mm/min for an extension of 50% in length at room temperature and further stretched at 12 mm/min for an extension of 110% in length at 120° C. The stretched HDPE/clay (3 wt %) film was further thermally set at 120° C. for 15 minutes.

### Fabrication of Porous Neat HDPE Film

The film fabrication steps for neat HDPE films are the same as described above and in Example 1, with the exclusion of the compounding stage.

### SEM Images of Clay, Porous Neat HDPE Film, and Porous HDPE/Clay Composite Film

The SEM images of the clay used, porous neat HDPE film and porous HDPE/clay composite film were measured by following the protocol in Example 1.

### AFM Image of Clay

The thickness of clay was measured by Bruker Dimension Edge™ atomic force microscope (AFM).

### Mechanical Properties Test of Porous Neat HDPE Film and Porous HDPE/Clay Composite Film

Both porous neat HDPE and porous HDPE/Clay composite film (3 wt %) were tested mechanically in machine direction according to the general protocol described in Example 1.

### Results and Discussions

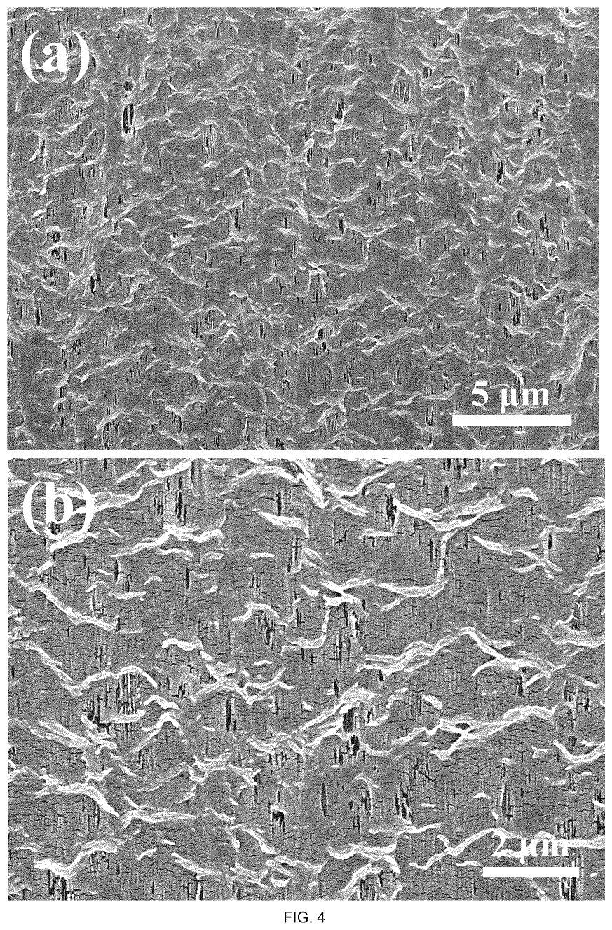

The SEM images of porous HDPE/clay (3 wt %) composite were shown in FIG. 4.

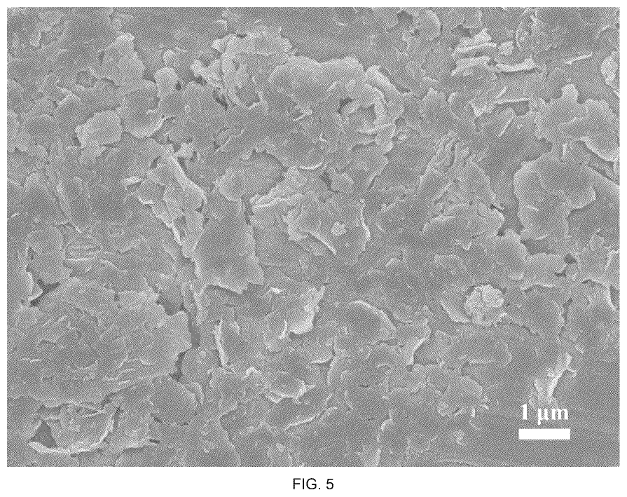

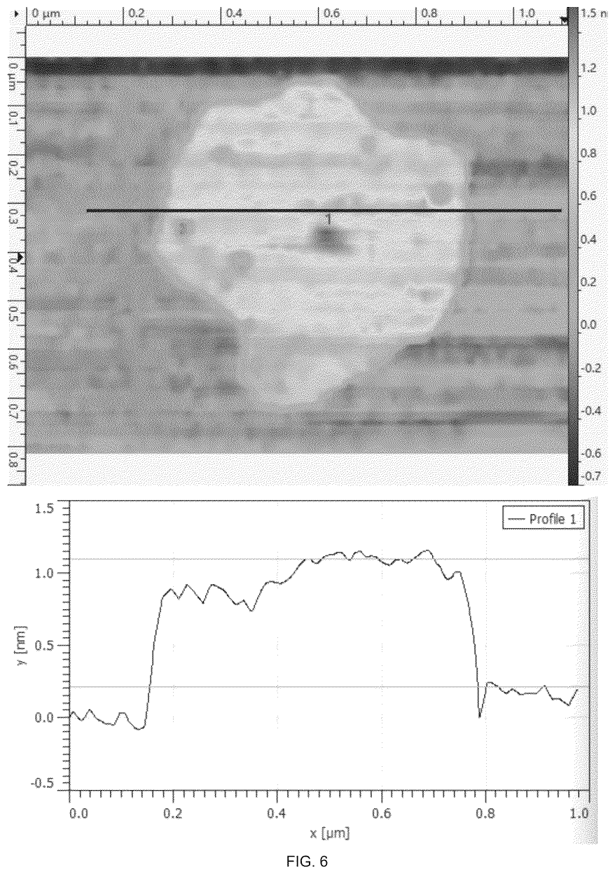

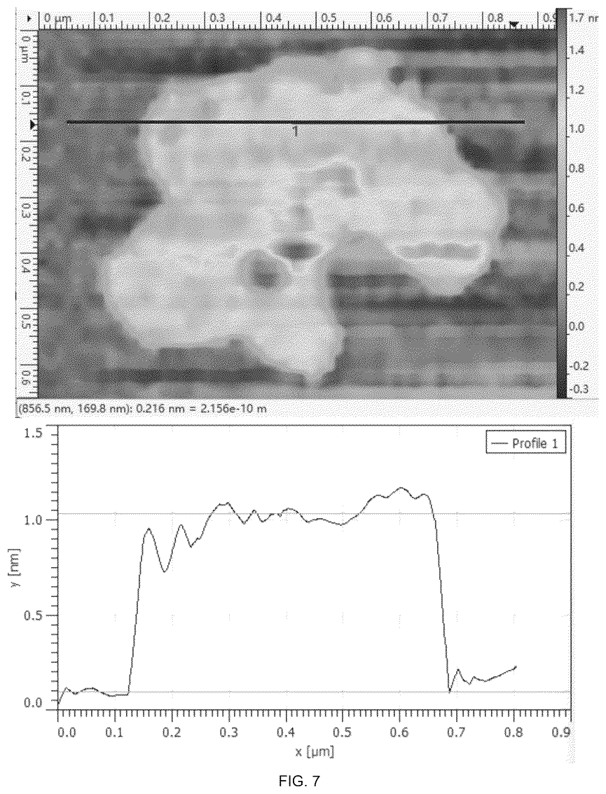

The clay used has average thickness 1 nm and planar length about 0.5-5 μm, which makes the aspect ratio (planar length/thickness) in the range of about 500-5000 (FIG. 5, FIG. 6, FIG. 7,). The introduction of clay with such high aspect ratio has shown improvement in the mechanical performance of porous polyolefins in this Example. Porous neat HDPE and porous HDPE/clay (3 wt %) composite film were tested mechanically in machine direction. The strength of neat porous HDPE films was tested to have an average of 80.2 MP a while porous HDPE/clay (3 wt %) film obtained a strength value of 91.8 MPa, achieving an improvement of 14.4%. The modulus increased from 249.6 MPa of neat HDPE to 272.0 MPa of HDPE/clay (3 wt %) composite, with an increment of 9.0%. The strain at break for both samples have maintained, both exceeding 160%, indicating that ductility is not compromised for the composite. The results were summarized in Table 3.

TABLE 3
Mechanical properties of porous neat HDPE and
porous HDPE/clay (3 wt %) composite film.

| | | | HDPE/Clay | | |
|---|---|---|---|---|---|
| | Neat HDPE | | (3.0 wt %) | | Change (Δ) |
| Strength (MPa) | 80.2 | (8.1) | 91.8 | (8.4) | 14.4% |
| Young's Modulus | 249.6 | (34.8) | 272.0 | (37.7) | 9.0% |
| (MPa) | | | | | |

Note:
the value in the bracket is the standard deviation.

### Example 5. Comparison of Neat PP Porous Hollow Fibre and PP/Graphene Composite (0.1 wt %) Porous Hollow Fibre

### Fabrication of Hollow Fibre Precursor

A polypropylene (P P, Sabic 500P) having a density of 9.05 g/cm³ and melt flow index of 3.0 was spun into hollow fibre with a fibre spinning equipment, which mainly contains extruder, gear pump and diehead. To produce the unstretched precursor hollow fibre, the zone 1, zone 2, zone 3 and zone 4 of the extruder are kept at 170° C., 220° C., 230° C. and 220° C., respectively. The temperature for the extruder end, gear pump and diehead are all kept at 190° C. The diehead has OD 15 mm and ID 10 mm and extruder port area 0.98 cm². Nitrogen was used for the bore gas, which has flow rate of 10 ml/min. The PP melt was extruded from the diehead at a speed of 4.4 cm/min and collected at a takeup speed of 81 m/min using a winder, which make a draw ratio of 1825. PP/graphene composite precursor fibre with graphene loading 0.1 wt. % was produced by premixing the neat PP and PP masterbatch with 5.0 wt % before introduced into the extruder hopper. The graphene used in this example, which can also be called as few-layer graphene or few-layer graphite, has a planar width between 100-2000 nm and thickness around 1 nm, making the aspect ratio in the range of about 100-2000. All other parameters are kept same as the neat PP during hollow fibre precursor fabrication. Both the neat PP and graphene filled PP precursor fibre were thermally annealed at 140° C. for 30 minutes in the oven before stretching.

### Fabrication of Porous Hollow Fibre

To produce the porous structure, the neat PP and graphene composite fibre were made into 300 loops with diameter 34 cm and then loaded into the stretching equipment with the two ends of the loops fixed by the hooks in the stretcher. The fibres were cold stretched at room temperature to 60 cm long with a stretching speed 10 mm/min, and further hot stretched at 140° C. to final length of 140 cm with a stretching speed 10 mm/min, making the total stretching ratio 260% (final length/original length). Immediately after the stretching process completed, the neat porous PP hollow fibre and porous graphene composite hollow fibre were thermally stabilized at 140° C. for 30 minutes.

### SEM Images of Neat PP Porous Hollow Fibre and Graphene Composite Porous Hollow Fibre

The SEM images of neat PP porous hollow fibre and graphene composite porous hollow fibre were measured by following the protocol in Example 1.

### Mechanical Properties Test of Neat PP Porous Hollow Fibre and Graphene Composite Porous Hollow Fibre

Both neat PP porous hollow fibre and PP/graphene composite (0.1 wt %) porous hollow fibre were tested mechanically in fiber direction according to the general protocol described in Example 1.

### Permeability Test

To decide the permeability of porous hollow fibres, a module is fabricated using 20 fibres with length of 30 cm. The bundles of fibres are immobilized with epoxy in a tube with dimeter 8 mm, and sealed for one end while the other is connected to the sucking pump. The module is soaked in IPA for 15 minutes and washed with water before the permeability test to make the fibres more hydrophilic. The amount of water sucked into the lumen of hollow fibre was used to calculate the permeability with the surface area of fibres considered.

### Rejection Rate Test

To test the rejection rate of porous hollow fibres, a yeast solution with concentration of 1 g/L was prepared. The rejection rate was defined as the ratio between the turbidity of produced water and the feed water. The turbidity was decided by Lovibond TB 211 IR infrared turbidimeter.

### Pore Size Analysis

The pore size analysis of porous hollow fibres was carried out by ultrafiltration membrane porometer GAOQ PSMA-20 (GaoQ Functional Materials Co., Ltd).

### Porosity Determination

The porosity of porous hollow fibre is calculated by the following equation (Eq. 3):

$$Porosity ( \% ) = ( 1 - \frac{{ρ}_{1}}{{ρ}_{2}} ) \times 100 \qquad Eq . 3$$

where ρ₁ and ρ₂ are the density of porous structure after stretching and the precursor before stretching.

### Results and Discussions

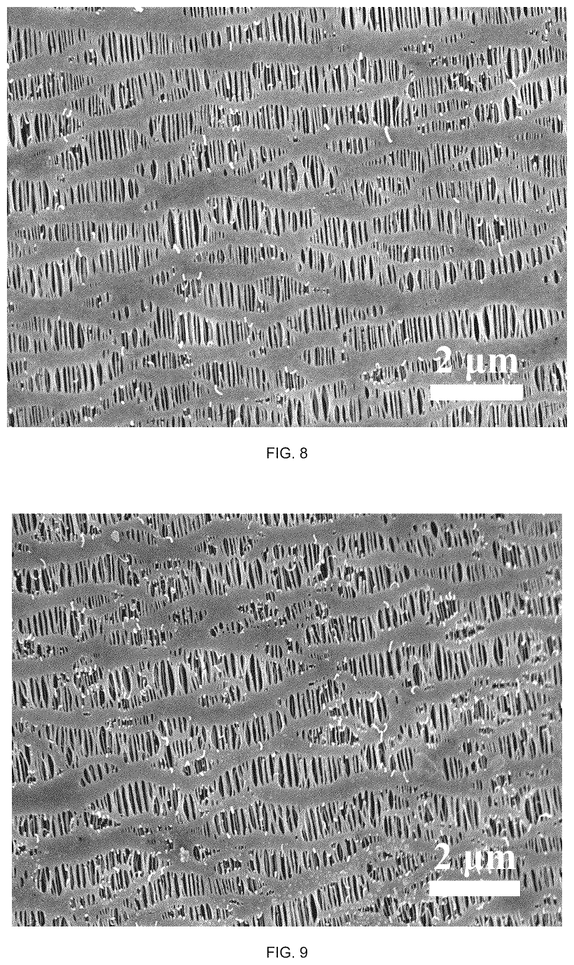

The neat PP porous hollow fibre and graphene composite porous hollow fibre have average diameter 439 and 435 um, with thickness 37 and 33 um, respectively. The morphology of neat PP porous hollow fibre and graphene composite porous hollow fibre were shown in FIG. 8 and FIG. 9. It is seen that large numbers of slot pores were produced from both types of hollow fibres. The porosity of neat PP porous hollow fibre and graphene composite porous hollow fibre were calculated to be 55% and 50.5%. According to the pore size analysis, the average pore size for neat PP porous hollow fibre and graphene composite porous hollow fibre are 50.6 and 47.6 nm, respectively. The permeability of pure water for neat PP porous hollow fibre and graphene composite porous hollow fibre are 192.2 and 196.5 LMH/bar, respectively. The rejection rate for yeast of neat PP porous hollow fibre and graphene composite porous hollow fibre are 99.07% and 99.96%. According to the mechanical test, the strength and strain of breakage of neat PP porous hollow fibre are 125 MPa and 136%, while that for graphene composite porous hollow fibre are 148 MPa and 170%, leading to increment of 18.4% and 25% for 0.1 wt % graphene filled porous hollow fibre compared with neat PP porous hollow fibre in terms of strength and strain at break.

### Example 6 Comparison of Neat PP Porous Hollow Fibre and PP/Graphene Composite (0.2 wt %) Porous Hollow Fibre

### Fabrication of Neat PP Porous Hollow Fibre and PP/Graphene Composite (0.2 wt %) Porous Hollow Fibre

Another PP/graphene composite precursor hollow fibre with graphene loading 0.2 wt. % was produced using PP/graphene composite pellets including 0.2 wt. % graphene which were fabricated by compounding neat PP and PP/graphene masterbatch with 5.0 wt. % graphene. PP/graphene composite precursor hollow fibre was manufactured according to the procedure described in Example 5. To produce the porous structure, the PP/graphene composite precursor hollow fibre was stretched according to the procedure described in Example 5.

### Results and Discussion

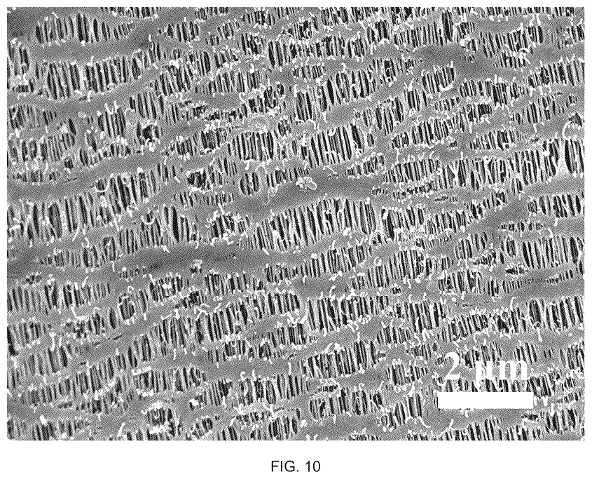

The graphene composite porous hollow fibre with 0.2 wt. % loading graphene has average diameter and wall thickness 443 and 33 um, respectively. The morphology of graphene composite porous hollow fibre was shown in FIG. 10. The porosity of this graphene composite porous hollow fibre were calculated to be 48.4%. According to the pore size analysis, the average pore size is 52.0 nm. The permeability of this graphene composite porous hollow fibre is 204.8 LMH/bar. The rejection rate for yeast is 99.9%. According to the mechanical test, the strength and strain of breakage are 138 MPa and 177%. Compared with neat PP porous hollow fibre in example 5, the strength and strain at break increased by 10.4% 30.1%, respectively.

In conclusion, the introduction of high aspect ratio fillers into porous polyolefins can effectively enhance the mechanical performance in biaxial direction while has limited negative effect on pore formation ability and filtration performance.

1. A porous composite material, comprising:
a polymeric matrix formed from one or more polyolefins; and
one or more high aspect ratio filler materials, wherein
the porous composite material has pores having a diameter of from 0.01 to 2 μm; and
the one or more high aspect ratio filler materials are present in an amount of from 0.05 to 30 wt % of the total weight of the porous composite material.

2. The porous composite material according to claim 1, wherein the one or more polyolefins each have generic repeating group of formula I: 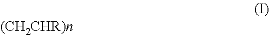
where R is an alkyl group.

3. The porous composite material according to claim 1, wherein the one or more polyolefins are selected from one or more of the group consisting of polyethylene (PE), polypropylene (PP), polymethylpentene (PMP), polybutene-1 (PB-1), ethylene-octene copolymers, stereo-block PP, olefin block copolymers, or propylene-butane copolymers.

4. The porous composite material according to claim 1, wherein each of the one or more polyolefins has a density of from 0.8 to 0.99 g/cm³.

5. The porous composite material according to claim 1, wherein each of the one or more polyolefins has a melt flow index of from 0.1 to 30 g/10 min at 230° C./2.16 kg, as measured according to ASTM D1238.

6. The porous composite material according to claim 1, wherein the porous composite material further comprises one or more additives selected from the group consisting of stabilizers, plasticizers, lubricants, flame retardants, anti-aging materials, colorants, nucleating agents, odour-generating agents, anti-microbial materials, anti-static additives or compatilizers.

7. The porous composite material according to claim 1, wherein the one or more high aspect ratio filler materials are a material that has a high ratio of length or width versus cross-sectional diameter and/or thickness, where the ratio is from 5 to 100,000.

8. The porous composite material according to claim 1, wherein
the one or more high aspect ratio filler materials are present in an amount of from 0.01 to 30 wt % of the total weight of the porous composite material.

9-10. (canceled)

11. The porous composite material according to claim 1, wherein the one or more high aspect ratio filler materials have a size of from 1 nm to 1,000 μm.

12-13. (canceled)

14. The porous composite material according to claim 1, wherein the high aspect ratio filler materials have an aspect ratio of from 5 to 100,000.

15. The porous composite material according to claim 1, wherein the porous composite material has one or both of:
a mechanical strength that is from 5 to 1,000% higher higher in a transverse direction for a film or in a circumferential direction for a fiber/tube formed from the polyolefin alone; and
a maximum strain that that is from 10 to 50,000% higher higher in a transverse direction for a film or in a circumferential direction for a fiber/tube formed from the polyolefin alone.

16. The porous composite material according to claim 1, wherein the porous composite material has one or both of:
a mechanical strength that is from 5 to 100% higher in a machine direction of a film or longitudinal direction of fiber/tube formed from the polyolefin alone; and
a Young's modulus that that is from 7 to 100% higher in a machine direction of a film or longitudinal direction of fiber/tube formed from the polyolefin alone.

17. A semi-permeable filter membrane formed of a film of a porous composite material according to claim 1.

18. The semi-permeable filter membrane according to claim 17, wherein one or both of the following apply:
the filter membrane has an average air flux of from 1,000 LMH to 10,000 LMH when measured at 1 bar of pressure; and/or
the filter membrane has a water permeability of from 50 LMH/bar to 1000 LMH/bar.

19. A separator membrane for a battery comprising a porous composite material according to claim 1.

20. A method of providing a porous composite material according to claim 1, the method comprising the steps of:
(a) providing a polyolefin composite precursor material that has been subjected to melt extrusion, thermal annealing, cold stretching and hot stretching; and
(b) subjecting the polyolefin composite precursor material that has been subjected to melt extrusion, thermal annealing, cold stretching and hot stretching to a thermal setting step at a certain temperature for a certain period of time.

21. (canceled)

22. The method according to claim 20, wherein the polyolefin composite precursor material that has been subjected to melt extrusion, thermal annealing, cold stretching and hot stretching is provided by:
(ai) providing a polyolefin composite precursor material that has been subjected to melt extrusion, thermal annealing, and cold stretching; and
(aii) subjecting the polyolefin composite precursor material to hot stretching at a certain temperature, a certain length per minute and at a certain extension.

23. (canceled)

24. The method according to claim 20, wherein the polyolefin composite precursor material that has been subjected to melt extrusion, thermal annealing, and cold stretching is provided by:
(bi) providing a polyolefin composite precursor material that has been subjected to melt extrusion, thermal annealing, and cold stretching; and
(bii) subjecting the polyolefin composite precursor material to cold stretching at a certain temperature, a certain length per minute and at a certain extension.

25. (canceled)

26. The method according to claim 20, wherein the polyolefin composite precursor material that has been subjected to melt extrusion and thermal annealing is provided by:
(ci) providing a polyolefin composite precursor material that has been subjected to melt extrusion and thermal annealing; and
(cii) subjecting the polyolefin composite precursor material to thermal annealing at a certain temperature for a certain period of time.

27. (canceled)

28. The method according to claim 20, wherein the polyolefin composite precursor material that has been subjected to melt extrusion is provided by:
(di) providing a polyolefin composite precursor material; and
(dii) subjecting the polyolefin composite precursor material to melt extrusion at a certain temperature and at a certain draw ratio, wherein:
the porous composite material, comprises:
a polymeric matrix formed from one or more polyolefins; and
one or more high aspect ratio filler materials, wherein
the porous composite material has pores having a diameter of from 0.01 to 2 μm; and
the one or more high aspect ratio filler materials are present in an amount of from 0.05 to 30 wt % of the total weight of the porous composite material.

29. (canceled)
